(19) United States
(12) Patent Application Publication
(10) Pub. No.: US 2025/0249364 A1
(43) Pub. Date: Aug. 7, 2025

(54) INFORMATION PROCESSING APPARATUS, INFORMATION PROCESSING METHOD, AND STORAGE MEDIUM

(71) Applicant: SNK Corporation, Osaka (JP)

(72) Inventors: Nobuyuki Kuroki, Osaka (JP); Omito Hashimoto, Osaka (JP)

(73) Assignee: SNK Corporation, Osaka (JP)

(21) Appl. No.: 19/029,482

(22) Filed: Jan. 17, 2025

(30) Foreign Application Priority Data
Feb. 5, 2024 (JP) 2024-015829

(51) Int. Cl. A63F 13/56; A63F 13/537; G06T 11/00

(52) U.S. Cl. CPC A63F 13/56; A63F 13/537; G06T 11/001

(57) ABSTRACT

There is an information processing apparatus capable of demonstrating that cancellation is performed on a game. The information processing apparatus includes: a reception part configured to receive, from a user, a manipulation input associated with a character the user manipulates in a virtual space; a display control part configured to perform a display in which the character takes an action based on the manipulation input; and a determination part configured to determine whether or not the manipulation input received by the reception part is a cancellation input capable of cancelling the action the character is taking. When the manipulation input is determined to be the cancellation input by the determination part, the display control part displays an afterimage of the character at a time of receiving the cancellation input.

### CROSS-REFERENCE TO RELATED APPLICATIONS

This application claims priority to Japanese Patent Application No. 2024-015829, filed Feb. 5, 2024, which is incorporated herein by reference in its entirety.

### TECHNICAL FIELD

This disclosure relates to an information processing apparatus and an information processing method which perform a display of a cancellation process in a game, and a non-transitory computer-readable storage medium storing an information processing program.

### BACKGROUND

There are widely known e-sports. A PvP (Player VS. Player) fighting game is developing more and more as one of the e-sports. The PvP fighting game is a game in which a user manipulates his (her) own character to defeat an opponent's character. The PvP fighting game has various techniques. As one of the techniques, there is a process called cancellation. The cancellation may be basically a process of forcibly stopping (cancelling) an action process so far and executing a next action. For example, when a guard input is made to defend against the opponent's attack, in most PvP fighting games, a lag of several frames (one frame is, for example, 1/60 seconds) from when the defense is made until a next input is received, may often occur. In that case, cancellation (which is sometimes referred to as a guard cancellation) of performing a specific input at a certain timing during guard to forcibly release a guard state, receiving an input associated with a next action corresponding to the specific input, and reflecting the same to the game, may be executed. That makes it possible to immediately reflect the next action to the game. Thus, the user may progress the game advantageously. Japanese Laid-Open Patent Publication No. 2023-106952 discloses such a cancellation process.

However, in the known cancellation, instantaneous events of several frames may be generated frequently during the game. As a result, a user or the like who is watching the game may not recognize that the cancellation is made, which makes it difficult to understand how the game progresses. Accordingly, the user who is watching the game may find the game boring.

It could therefore be helpful to provide an information processing apparatus and an information processing method which are capable of easily recognizing a cancellation made by a user, and a non-transitory computer-readable storage medium storing an information processing program.

### SUMMARY

Disclosed herein is an information processing apparatus including: a reception part configured to receive, from a user, a manipulation input associated with a character the user manipulates in a virtual space; a display control part configured to perform a display in which the character takes an action based on the manipulation input; and a determination part configured to determine whether or not the manipulation input received by the reception part is a cancellation input capable of cancelling the action the character is taking. When the manipulation input is determined to be the cancellation input by the determination part, the display control part displays an afterimage of the character at a time of receiving the cancellation input.

Also disclosed herein is an information processing method including: receiving, from a user, a manipulation input associated with a character the user manipulates in a virtual space; performing a display in which the character takes an action based on the manipulation input; and determining whether or not the manipulation input is a cancellation input capable of cancelling the action the character is taking. When the manipulation input is determined to be the cancellation input, the performing the display includes displaying an afterimage of the character at a time of receiving the cancellation input.

Further disclosed herein is a non-transitory computer-readable storage medium storing an information processing program for executing a process by a computer, the process including: receiving, from a user, a manipulation input associated with a character the user manipulates in a virtual space; performing a display in which the character takes an action based on the manipulation input; and determining whether or not the manipulation input is a cancellation input capable of cancelling the action the character is taking. When the manipulation input is determined to be the cancellation input, the performing the display includes displaying an afterimage of the character at a time of receiving the cancellation input.

In addition, the information processing apparatus may further include: when the manipulation input is determined to be the cancellation input by the determination part, a production part configured to produce an afterimage indicating the afterimage based on a display image in the action the character is taking. The display control part may display the afterimage generated by the production part as the afterimage of the character.

Further, in the information processing apparatus, the production part may produce the afterimage having a display aspect different from a normal display aspect of the character.

Further, in the information processing apparatus, the cancellation input may be a subsequent manipulation input indicating a next action the character takes subsequently. The display control part may be configured to perform a control in which both the afterimage and the next action the character takes subsequently are displayed.

According to the information processing apparatus of this disclosure, when a user makes a cancellation, it is possible to display an afterimage of a character of the user who made the cancellation. Therefore, the user can easily recognize that the cancellation has executed.

### BRIEF DESCRIPTION OF THE DRAWINGS

FIG. 1 is a block diagram illustrating a configuration example of an information processing apparatus.

FIG. 2 is a flowchart illustrating an operation example of the information processing apparatus.

FIG. 3 is a first screen example of a game.

FIG. 4 is a second screen example of the game.

FIG. 5 is a third screen example of the game.

FIG. 6 is a fourth image example of the game.

### EXPLANATION OF REFERENCE NUMERALS

100: Information processing apparatus
110: Communication part
120: Input part
130: Output part
140: Storage part
150: Control part
151: Reception part
152: Display control part
153: Determination part
154: Production part

### DETAILED DESCRIPTION

Hereinafter, our information processing apparatus will be described with reference to the drawings.

### Example Embodiment

### Configuration

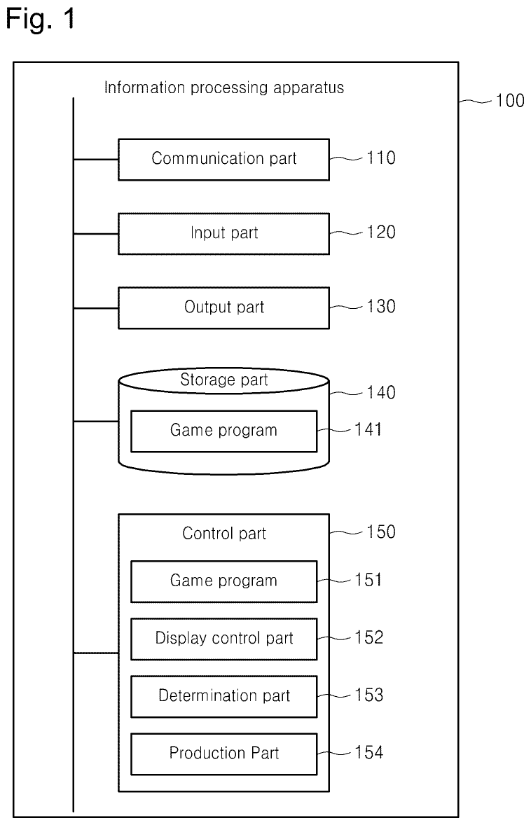

FIG. 1 is a block diagram illustrating a configuration example of an information processing apparatus 100. The information processing apparatus 100 is an apparatus which receives a user's input and reflects the input to contents of a game to output a game screen. The information processing apparatus 100 is a computer system including a processor and a memory. The information processing apparatus 100 may be implemented by a so-called personal computer (PC), a notebook PC, a tablet device, a server apparatus, a smartphone, a game machine, or the like, but is not limited thereto. Further, the information processing apparatus 100 may be implemented by a single apparatus, and may be implemented by a parallel-type computer system with a plurality of computers.

The information processing apparatus 100 is an apparatus which provides the game screen by executing a game program stored in the memory and operating a character manipulated by the user on a game world (virtual space) provided by the game program. In this example embodiment, descriptions will be made by taking, as an example of the game, a PvP (Player VS. Player) fighting game. The PvP fighting game is a computer-based game in which the character the user manipulates and another character (which may be a character another user manipulates or a computer-based character manipulated by a computer based on a predetermined algorithm) compete against each other to satisfy victory conditions (to basically defeat an opponent's character).

The information processing apparatus 100 is an apparatus which receives individual inputs made by a plurality of users, processes each input, and outputs a game screen including characters corresponding to the users to a monitor provided in the information processing apparatus 100 or a monitor connected to the information processing apparatus 100. Alternatively, the information processing apparatus 100 may be a server apparatus which provides the game screen to an information processing apparatus (a PC, a smartphone, a game machine, or the like) of each of the plurality of users via a network. Further, the information processing apparatus 100 may be an apparatus which directly communicates with an information processing apparatus of an opponent (or communicates with the information processing apparatus of the opponent via a network), and provides a game screen obtained by synchronizing input contents performed by respective information processing apparatuses to each monitor.

In the information processing apparatus 100 according to an example embodiment, when a cancellation process is established during the game based on an input made by a user, an afterimage of the character the user manipulates at the time of the cancellation process is displayed to demonstrate to a user who is playing the game or a user who is watching the game that the cancellation is made.

Hereinafter, a detailed description will be given. An afterimage display process in the cancellation process will be mainly described and descriptions of a process normally performed in the PvP fighting game (for example, a process of receiving a kick execution input, causing a character to take a kick action, performing a strike determination process on an opponent who receives the kick action, or the like) will be omitted.

As illustrated in FIG. 1, the information processing apparatus 100 includes a communication part 110, an input part 120, an output part 130, a storage part 140, and a control part 150.

The communication part 110 is a communication interface which communicates with another information processing apparatus outside the information processing apparatus 100 and performs a function to enable transmission/reception of information. The communication part 110 may receive information necessary for the execution of the game by communicating with another information processing apparatus and transmit the information to the control part 150. Further, another information processing apparatus may transmit the information necessary for the execution of the game to still another information processing apparatus. In a case in which the information processing apparatus 100 provides the game screen by communicating with another information processing apparatus via a network, for example, the communication part 110 may receive a game-related input content transmitted from another information processing apparatus and transmit the same to the control part 150. Further, for example, the communication part 110 may transmit a game-related information (for example, display information of the game screen) to another information processing apparatus according to an instruction from the control part 150.

The input part 120 may receive a game-related input made by the user and transmit the same to the control part 150. As an example, the input part 120 may be implemented with a mouse, a touch pad, a keyboard, a game pad, a joy stick, an arcade controller, or the like, but is not limited thereto. For example, the input part 120 may receive an input for moving a character, an input for causing the character to take a defensive stance, an input for causing the character to take an offensive stance or the like, and may transmit the same to the control part 150. Further, the input part 120 may receive an input for causing the character to perform a specific technique by combining a specific direction with a specific button, and may transmit the same to the control part 150.

The output part 130 has a function of outputting information specified by the control part 150. For example, the output part 130 may be implemented with a monitor provided in the information processing apparatus 100 or a monitor connected to the information processing apparatus 100. Further, for example, the output part 130 may be implemented with a speaker provided in the information processing apparatus, or a speaker or an earphone connected to the information processing apparatus 100. Based on an instruction from the control part 150, the output part 130 may output an image constituting a game screen, or output a game-related sound (for example, a game's background music (BGM) or a character's voice).

The storage part 140 has a function of storing a program or various pieces of data necessary for the operation of the information processing apparatus 100. For example, the storage part 140 may be implemented with a storage medium such as a hard disk drive (HDD), a solid-state drive (SSD), a flash memory or the like. The storage part 140 may include a random-access memory (RAM) or a read-only memory (ROM). The storage part 140 stores a game program 141. The game program 141 may be a computer program for providing the PvP fighting game to the user, and may be a program for describing information for causing each character to take any action, a method of determining actions in the game and whether or not the actions are possible.

The control part 150 is a processor for controlling each part of the information processing apparatus 100. The control part 150 implements functions to be executed by the information processing apparatus 100 by executing various programs using various pieces of data stored in the storage part 140. The control part 150 may execute the game program 141 to provide the game implemented by the game program 141 to the user.

The control part 150 includes a reception part 151, a display control part 152, a determination part 153, and a production part 154. The reception part 151, the display control part 152, the determination part 153, and the production part 154 may be functional modules implemented by executing the game program 141.

The reception part 151 receives a manipulation input relating to the character, which is made by the user on a game screen (that is, a virtual space provided by the game). The reception part 151 may receive the manipulation input via the input part 120, and may receive the manipulation input from another information processing apparatus as a communication destination via the communication part 110. The reception part 151 transmits the received manipulation input to the display control part 152 and the determination part 153.

The display control part 152 performs an image process of displaying the action the respective character has taken based on the manipulation input received by the reception part 151. When the determination part 153 determines that the manipulation input received by the reception part 151 is the cancellation input, the display control part 152 may display the afterimage produced by the production part 154 for a predetermined period of time (for example, several frames) at a display position of the character at a time when the cancellation input is made. After the predetermined period of time, the display control part 152 may quickly erase (may not display) the afterimage. Alternatively, the display control part 152 may perform a display control in which the afterimage gradually blurs and disappears from the game screen. Meanwhile, when the determination part 153 determines that the manipulation input received by the reception part 151 is not the cancellation input, the display control part 152 may determine whether or not the manipulation input is executable at that time point. When it is determined that the manipulation input is executable, the display control part 152 may display the action the character takes to correspond to the manipulation input.

The determination part 153 determines whether or not the manipulation input received by the reception part 151 is the cancellation input capable of cancelling the action the character is taking at that reception time point. The cancellation input may be an input for forcibly stopping the action the character is currently taking. Alternatively, the cancellation input may be an input capable of specifying a next action content to be executed by the character immediately after forcibly stopping the action the character is currently taking. Specifically, as an example, at the time when the reception part 151 receives the manipulation input, the determination part 153 may determine whether or not the manipulation input is the cancellation input capable of cancelling the action according to whether or not an image (a frame number in an animation) displayed in the action (the animation) the character is taking is an image (a frame number in the animation) set to allow the cancellation input to be received on the game program. Further, as an example, the determination part 153 may determine whether or not the received manipulation input is a special input receivable as the cancellation input in consideration of the time when the manipulation input is received. When the received manipulation input is determined to be the cancellation input, the determination part 153 may notify the display control part 152 and the production part 154 of the presence of the cancellation input. When the received manipulation input is determined to be not the cancellation input, the determination part 153 may determine that no manipulation input is received and may delete the same.

When the determination part 153 determines that the manipulation input is the cancellation input (determines that the user has successfully made the cancellation input), the production part 154 may copy a display image of a character (that is, the character the user manipulates) displayed at the time when the cancellation input is made, and may produce an afterimage based on the copied display image. The production part 154 may produce an afterimage of a display aspect different from a normal display aspect of the character. The expression “the afterimage of a display aspect different from a normal display aspect of the character” may refer to, for example, an image in which a color of the character is monotone, an image in which the color of the character is monotone and a contour line of the character is expressed to have a degree of grayscale, or an image in which the character is displayed while being subject to a permeation display treatment and a background image is viable at the display position of the character. The afterimage may be produced without a shadow. Further, the afterimage may be produced as a copied image of the same display aspect as the normal display aspect.

The foregoing description relates to the configuration example of the information processing apparatus 100.

### Operation

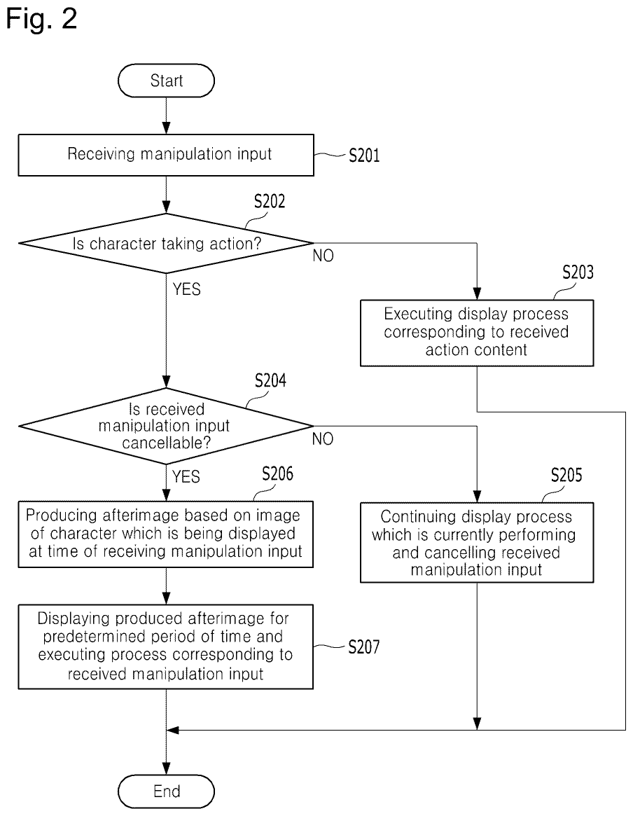

FIG. 2 is a flowchart illustrating an operation example of the information processing apparatus 100, which illustrates a process when an input made by a user during a game is received. In FIG. 2, a cancellation process in a game program will be described as an example of the process. Further, an example in which the PvP fighting game is provided individually to a plurality of users using the information processing apparatus 100 will be described. Further, the process may also be applied to an example in which the PvP fighting game is provided individually to the plurality of users using a plurality of information processing apparatuses via a network.

As illustrated in FIG. 2, in the information processing apparatus 100, the reception part 151 of the control part 150 receives a manipulation input associated with a character from the user via the input part 120 (in Step S201). The reception part 151 transmits a content of the received manipulation input to the display control part 152.

The display control part 152 determines whether or not the character corresponding to the received manipulation input (that is, the character manipulated by the user who has made the manipulation input) is taking any kind of action at a timing of receiving the manipulation input (in Step S202). Examples of any kind of action used herein may include an action being executed according to a previously-input process, for example, an offensive motion, a guard motion, a motion which executes a process when the user's character is attacked by an opponent, and the like. When the character is determined not to be taking any kind of action and to be in a state where the character can take an action corresponding to the received manipulation input (NO in Step S202), the display control part 152 executes a display process in which the character has taken the action corresponding to the content of the received manipulation input (in Step S203), and subsequently, completes the process corresponding to the received manipulation input. In an example embodiment, the control part 150 may determine whether or not the character has been attacked as a process required for the game. When it is determined that the character has been attacked, the control part 150 may calculate a degree of damage due to such an attack, and perform a process of reflecting the degree of damage to the character.

When the character is determined to be taking any kind of action in Step S202, the determination part 153 determines whether or not the received manipulation input is capable of cancelling a current action (in Step S204). That is, the determination part 153 determines whether or not the received manipulation input corresponds to a frame to which the cancellation input may be applied to the action the character is currently taking (the action being currently displayed). When the determination part 153 determines that the received manipulation input is not capable of cancelling the current action (NO in Step S204), the display control part 152 continuously performs the display process which is currently running, deletes (that is, does not execute) the received manipulation input (in Step S205). Thereafter, the process ends.

Meanwhile, when it is determined by the determination part 153 in Step S204 that the received manipulation input is capable of cancelling the current action (that is, the cancellation input), the production part 154 produces the afterimage based on an image of the character being displayed at the time of receiving the manipulation input (in Step S206). Subsequently, the display control part 152 processes a next action of the character, which corresponds to the received manipulation input, while displaying the afterimage produced by the production part 154 at a position where the character is displayed for a predetermined period of time (in Step S207). Thereafter, the process ends.

The process illustrated in FIG. 2 is a process executed on one manipulation input. The process may be executed every time the input is made while playing the PvP fighting game. The foregoing description relates to the process executed on the manipulation input by the information processing apparatus 100.

### Display Example

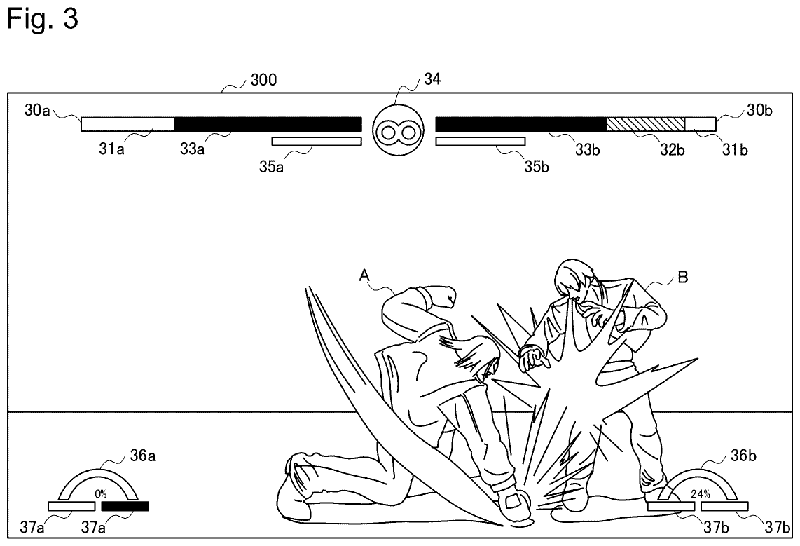

Next, the display of the afterimage at the time of cancellation in the game according to this example embodiment will be described in detail with reference to FIGS. 3 to 6. FIGS. 3 to 6 are diagrams illustrating display examples of temporally-adjacent game screens.

FIG. 3 illustrates the display example of a game screen 300 representing a certain scene in the PvP fighting game. In the game screen 300 illustrated in FIG. 3, a character A and a character B who compete against each other are displayed and various pieces of information about the PvP fighting game are displayed. In the game screen 300 illustrated in FIG. 3, there are illustrated, as pieces of game-related information, physical capacity gauges 30a and 30b indicating a physical capacity of each character, a time information 34 indicating a remaining time of the PvP fighting game, guard crush gauges 35a and 35b indicating an extent to which the physical capability of the respective character is completely consumed by defending (guarding) against the opponent's attack and eventually entirety open to the opponent's attack, super killer technique gauges 37a and 37b indicating whether or not a super killer technique capable of significantly inflicting damage on the opponent by further consuming the physical capability is executable, and gauges 36a and 36b indicating an accumulation status of one super killer technique.

In FIGS. 3 to 6, the time information 34 is indicated infinity. The time information 34 indicates that the PvP fighting game does not end until one character falls. The time information 34 may be set by the user(s) who plays the PvP fighting game.

In addition, the super killer technique gauge may be accumulated by a certain amount according to a predetermined action the character is taking. For example, when the character inflicts damage on the opponent, when the character suffers damage from the opponent, or the like, the super killer technique gauge may be accumulated. The accumulation amount may be varied according to a degree of damage. Further, the super killer technique gauge may be accumulated over time. Further, in FIGS. 3 to 6, the presence of the super killer technique gauge is indicated by a white empty image and the absence of the super killer technique gauge is indicated by a solid black image.

In addition, the physical capacity gauge 30 may include a remaining physical capacity 31a and 31b indicating a state in which the physical capacity remains, a damage amount 32b indicating, when the character is under attack, an amount of physical capacity consumed by the attack in real time, that is, a degree of damage caused by the attack, and a consumption physical capacity 33a and 33b indicating a physical capacity consumed.

Further, in FIGS. 3 to 6, information about each character is indicated by adding an alphabet representing each character to the end of the respective reference numeral.

In FIG. 3, the character A is in a state of creating one of killer techniques. Such a killer technique is expressed by an animation in which a plurality of predetermined frames is successively displayed. Therefore, the killer technique, which is input primarily, may continue to be basically expressed until the animation associated with the killer technique ends or until the character A is attacked by the opponent (that is, the character B). That is, a display corresponding to a next input is not processed. However, according to a specification of a game, an input made by the user may be received at a specific time during the process of the animation. This disclosure is not limited thereto. As an example, in a case in which the killer technique is expressed by an animation of 20 frames, when a specific input made by the user is received between 12th frame and 15th frame, a display process of the character, which corresponds to the specific input, may be executed. As described above, the specific input is referred to as the cancellation input capable of forcibly stopping the action the character is taking so far at the specific time. Further, when the specific input is received, the information processing apparatus 100 stops the display process of the animation which was being displayed until the specific input is received, and causes the character to take an action corresponding to the received specific input.

At this time, the information processing apparatus 100 copies an image of the character displayed at the time when the cancellation input is made. The information processing apparatus 100 produces the afterimage in which the character is expressed by indicating the copied image in a color different from an original color or applying gradation representing that the copied image is the afterimage to easily recognize the copied image as the afterimage. The information processing apparatus 100 outputs the afterimage on the game screen.

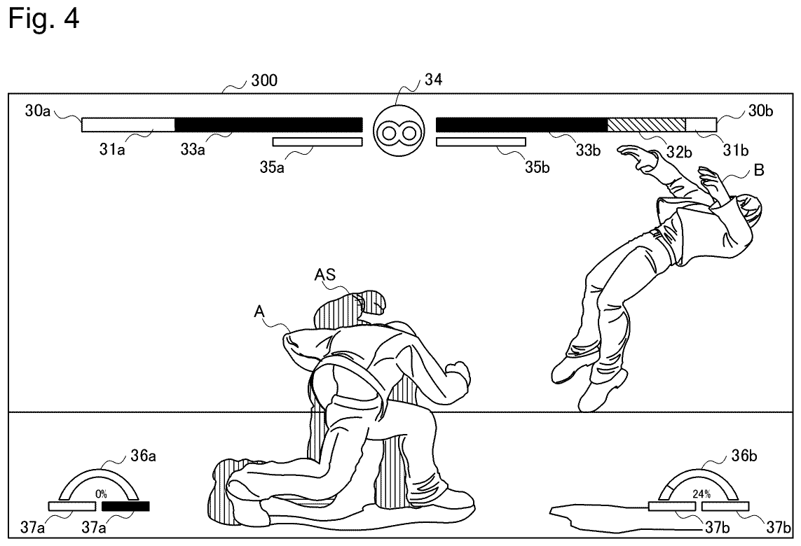

FIG. 4 illustrates an example of the game screen when the cancellation input is made.

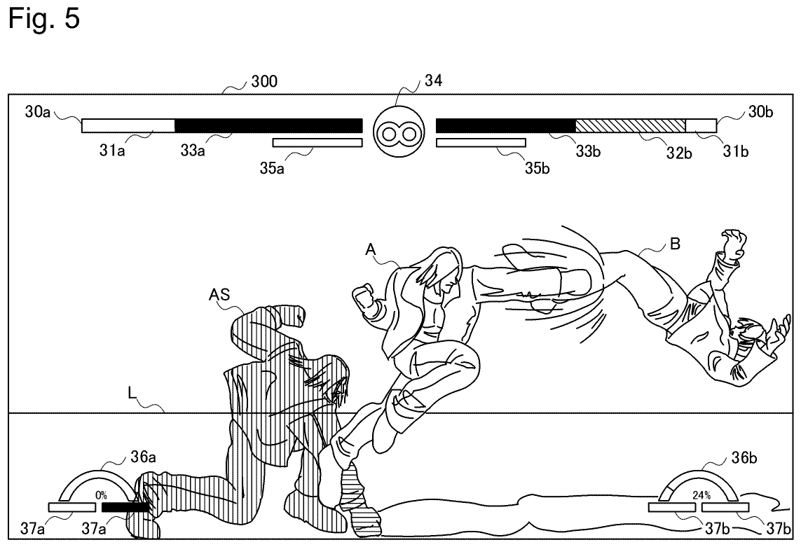

FIG. 5 illustrates an example of a game screen in which, when the cancellation input is established, the character takes an action according to the received manipulation input, which corresponds to the cancellation input.

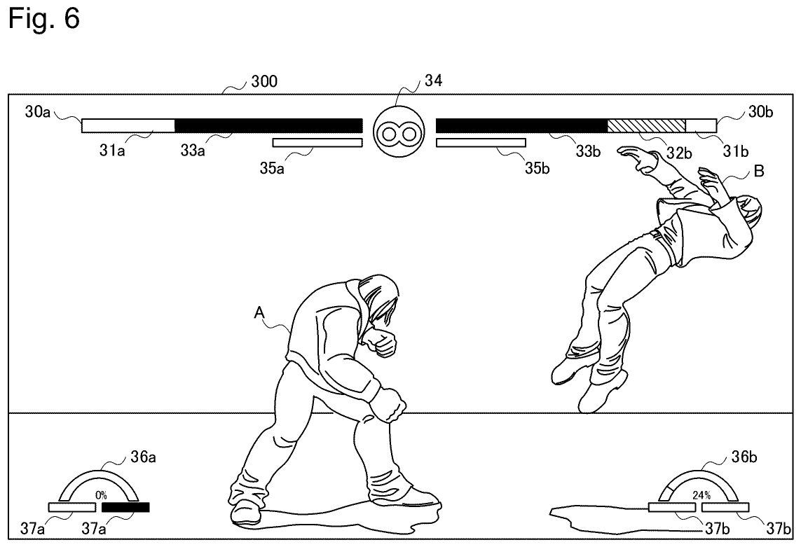

Typically, there is a case in which the cancellation input is not established after the state illustrated in FIG. 3. For example, as illustrated in FIG. 6, a situation in which the character A is standing up from the state of FIG. 3 may be displayed. In this case, as illustrated in FIG. 6, it is needless to say that the afterimage is not displayed. In this case, it is assumed that a specification of the game is programmed to receive the cancellation input according to the specific input made by the user in the state illustrated in FIG. 3. Further, when the user makes the specific input and the information processing apparatus 100 determines that the specific input is the cancellation input, as shown in FIG. 4, an afterimage AS of the character A is displayed, the process of the action so far is canceled, and the display process of the action corresponding to the received manipulation input is executed. Thereafter, as illustrated in FIG. 5, the character A cancels (that is, forcibly ends) the action taken so far, and takes an action corresponding to a content of the manipulation input received as the cancellation input. In an example illustrated in FIG. 5, there is illustrated a state in which the character A takes a next offensive stance. The afterimage AS illustrated in each of FIGS. 4 and 5 is hatched in vertical lines to indicate that they are afterimages. In addition, as illustrated in FIG. 5, the afterimage AS may be subjected to the permeation display treatment so that a background image (a background line L in FIG. 5) is displayed in a permeation manner. In addition, as illustrated in FIG. 5, the afterimage AS may be depicted without a shadow.

A successful establishment of the cancellation input enables the character to take a next offense action quickly as compared with the normal case, which makes it possible to inflict more damage on the opponent. Further, when the cancellation input is established, the afterimage AS is displayed as illustrated in the figures. Thus, the user who is looking at the game screen may easily recognize that the cancellation input has been made at that time.

### CONCLUSION

As described above, the information processing apparatus 100 displays the cancellation made by the user during the game as the afterimage of the character the user manipulates to demonstrate to the user playing the game, or a user(s) watching the game. Accordingly, each user may visually recognize that the cancelling has made. Further, by leaving the afterimage, it is possible to provide an information processing apparatus (game) that makes it easy to recognize a cancellation point which has been difficult to recognize in previous games. Thus, the user(s) watching the game may recognize that the user playing the game has made an excellent manipulation input. In particular, the user playing the game may recognize that the cancellation input has been established along with the display of the afterimage. Thus, the user may actually feel an improvement in a play skill in the game the user is playing. Further, for example, by leaving the afterimage, the opponent may mistakenly believe that the user's character is at the location of the afterimage.

### Modifications

Although example embodiments have been described in the above, this disclosure is not limited thereto. Hereinafter, various modifications included in the scope of this disclosure will be described.

(1) In the above example embodiment, the PvP fighting game has been described as an example of the game executed by the information processing apparatus 100, but this disclosure is not limited to the PvP fighting game. The game may be any kind of game as long as it is an action game in which a character takes an action responsive to a manipulation input made by the user. The process of displaying the afterimage, which has been described in the above example embodiment, is applicable to games other than the PvP fighting game.

As an example, the game may be a cooperative game in which a plurality of users cooperates with each other to subjugate a monster. In this case, in the cooperative game in which characters of the plurality of users and the monster are displayed on one screen, when the user makes a cancellation, an afterimage of the character the user manipulates may be displayed. Further, in the cooperative game, a situation when viewed from the character of each of the plurality of users may be displayed on the screen of the respective user of the plurality of users. In this case, when another user makes a cancellation, the information processing apparatus may display an afterimage of the character another user manipulates.

Further, the game may be a roll playing game including action elements. In a case in which a specification capable of receiving a cancellation input is provided to the action elements, the information processing apparatus may display an afterimage of a character which has taken an action at a time when the cancellation input has established.

Further, the game may be, for example, a shooting game. In this shooting game, by making a specific input with respect to his (her) machine and making a cancellation input while executing a certain process, an afterimage of his (her) machine may be displayed to produce, for example, a scene of avoiding an offense from an enemy.

(2) In the above example embodiment, the display control part has been described to produce and display the game screen. In the case in which the plurality of information processing apparatuses competes against each other via a network, the game screen may be configured to be produced by the display control part of each of the plurality of information processing apparatuses. In this case, the plurality of information processing apparatuses may be configured to transmit/receive, to each other/from each other, a content of an input performed in each information processing apparatus and information about a time when the input is made. The plurality of information processing apparatuses may apply a process corresponding to the input content to a respective character, and may be synchronized with each other to provide the same game screen.

(3) In the above example embodiment, the display control part has been described to copy the display image of the character displayed at the time when the cancellation input is made, and produce and display the afterimage of the character based on the copied image. However, the display of the afterimage is not limited thereto. For example, an afterimage of each character at a time when a cancellation input may be made, may be previously prepared and stored in the storage part 140 in advance. At the time when the cancellation input has been made, whether or not the cancellation input is one occurred at any time and during any action may be determined. The afterimage corresponding to the respective cancellation input may be read out from the storage part 140 and may be displayed.

(4) In the information processing apparatus 100 according to the above example embodiment, the cancellation input has been described to be established when being input at a specific time while performing the action process (the display process) of the character, but this disclosure is not limited thereto. Depending on a specification of the game, the cancellation input may be established at any time according to a specific input scheme. In this case, an afterimage of the character (not only during a specific action in the animation but also during movement, jumping or the like) at the time when the cancellation input is made, may be produced and displayed.

(5) While not particularly described in the above example embodiment, the cancellation input may be executed when a specific resource in the game is consumed. For example, when the cancellation input is made and received, the super killer technique gauge 37a and 37b illustrated in FIG. 3 in the above example embodiment may be consumed. Further, a gauge dedicated to the cancellation input may be provided instead of the super killer technique gauge.

(6) In the above example embodiment, when it is determined by the determination part 153 that the received manipulation input is not the cancellation input, the received manipulation input may be deleted, but this disclosure is not limited thereto. The information processing apparatus 100 may receive the received manipulation input as a process to be executed after the end of the current action.

(7) In the above example embodiment, in a case in which the information processing apparatus 100 is a game machine or the like capable of providing a game individually, the information processing apparatus 100 does not have to include the communication part 110.

(8) In the above example embodiment, the guard crush gauges 35a and 35b may be omitted. Further, instead of (in addition to) the guard crush gauges 35a and 35b, another gauge, such as a faint gauge which is decreased every time a respective character is attacked by an opponent and is turned into a fainting state when the character dies, may be provided.

(9) In the above example embodiment, each of the plurality of functional parts of the information processing apparatus 100 may be implemented by a logic circuit (hardware) or a dedicated circuit, which is constituted with an integrated circuit (IC) chip, a large-scale integration (LSI), or the like, and may be implemented by software using a central processing unit (CPU) and a memory. Further, each functional part may be implemented by one or a plurality of integrated circuits. Functions of the plurality of functional parts may be implemented by one integrated circuit. LSI may be classified into VLSI (very-large-scale integrated circuit), Super LSI, Ultra LSI or the like depending on a difference in integration degree. Further, the term “circuit” used herein may encompass a computer-based digital process, that is, a software-based functional process. Further, the circuit may be implemented by a reconfigurable circuit (for example, a field programmable gate array (FPGA).

In the case in which each functional part of the information processing apparatus 100 is implemented by software, the information processing apparatus 100 may include a CPU configured to execute instructions incorporated in an image evaluation program, which is software for implementing each function, a read-only memory (ROM) and a storage device (hereinafter referred to as a “recording medium”) in which the image evaluation program and various pieces of data are recorded readably by a computer (or CPU), a random access memory (RAM) in which the image evaluation program is deployed, and the like. Further, by reading the image evaluation program from the recording medium and executing the image evaluation program by the computer (or CPU), the desired effect may be achieved. As the recording medium, “a non-transitory intangible medium” such as a tape, a disk, a card, a semiconductor memory, a programmable logic circuit, or the like may be used. Further, the image evaluation program may be supplied to the computer via any transmission medium (such as a communication network or broadcasting wave) capable of transmitting the image evaluation program. Further, this disclosure may be implemented in the form of a data signal in which the image evaluation program is embodied by electronic transmission or embedded in a carrier wave.

In addition, the image evaluation program may be implemented using, for example, a script language such as ActionScript, JavaScript (registered trademark) or the like, an object-oriented programming language such as C++, Objective-C, and Java (registered trademark) or the like, a markup language such as HTML5, or the like, but this disclosure is not limited thereto. For example, Ruby, Python, or the like may be used.

(10) Various configurations and aspects described in the above example embodiment may be appropriately combined with each other.

What is claimed is:

1. An information processing apparatus, comprising:
a reception part configured to receive, from a user, a manipulation input associated with a character the user manipulates in a virtual space;
a display control part configured to perform a display in which the character takes an action based on the manipulation input; and
a determination part configured to determine whether or not the manipulation input received by the reception part is a cancellation input capable of cancelling the action the character is taking, and
wherein, when the manipulation input is determined to be a cancellation input by the determination part, the display control part displays an afterimage of the character at a time of receiving the cancellation input.

2. The information processing apparatus of claim 1, further comprising:
when the manipulation input is determined to be the cancellation input by the determination part, a production part configured to produce the afterimage based on a display image in the action the character is taking,
wherein the display control part displays the afterimage produced by the production part as the afterimage of the character.

3. The information processing apparatus of claim 2, wherein the production part produces the afterimage of the character, which has a display aspect different from a normal display aspect.

4. The information processing apparatus of claim 1, wherein the cancellation input is a subsequent manipulation input indicating a next action the character takes subsequently, and
wherein the display control part is configured to perform a control in which both the afterimage and the next action the character takes subsequently are displayed.

5. An information processing method, comprising:
receiving, from a user, a manipulation input associated with a character the user manipulates in a virtual space;
performing a display in which the character takes an action based on the manipulation input; and
determining whether or not the manipulation input is a cancellation input capable of cancelling the action the character is taking, and
wherein, when the manipulation input is determined to be a cancellation input, the performing the display includes displaying an afterimage of the character at a time of receiving the cancellation input.

6. A non-transitory computer-readable storage medium storing an information processing program for executing a process by a computer, the process comprising:
receiving, from a user, a manipulation input associated with a character the user manipulates in a virtual space;
performing a display in which the character takes an action based on the manipulation input; and
determining whether or not the manipulation input is a cancellation input capable of cancelling the action the character is taking,
wherein, when the manipulation input is determined to be a cancellation input, the performing the display includes displaying an afterimage of the character at a time of receiving the cancellation input.
